(19) United States
(12) Patent Application Publication
(10) Pub. No.: US 2019/0262833 A1
(43) Pub. Date: Aug. 29, 2019

(54) Reactor Microplate

(71) Applicant: NanoRacks LLC, Webster, TX (US)

(72) Inventors: Cody Joseph Burgey, Roeland Park, KS (US); Michael Desmond Lewis, Kemah, TX (US); Brett Alan Shaffer, Houston, TX (US)

(73) Assignee: NanoRacks LLC, Webster, TX (US)

(21) Appl. No.: 16/289,598

(22) Filed: Feb. 28, 2019

Related U.S. Application Data
(60) Provisional application No. 62/636,543, filed on Feb. 28, 2018.

(51) Int. Cl. B01L 3/00; B01F 13/00

(52) U.S. Cl. CPC B01L 3/502738; B01F 13/0064; B01F 2215/0037; B01L 2300/0877; B01L 2400/0644; B01L 2300/0829

(57) ABSTRACT

A reactor microplate that allows for a researcher to perform a multitude of experiment in micro-gravity without risking potential exposure. The microplate includes a planar housing and an at least one chamber-mixing assembly. The chamber-mixing assembly includes a first retaining mechanism, a second retaining mechanism, a mixing channel, and an activation valve. The first retaining mechanism and the second retaining mechanism house solutions for an experiment and are positioned offset to each other, across the planar housing. The mixing channel fluidly couples the first retaining mechanism to the second retaining mechanism. Specifically, the mixing channel traverses into the planar housing from the first retaining mechanism to the second retaining mechanism. The activation valve is mechanically integrated in between the first retaining mechanism, the mixing channel, and the second retaining mechanism to control the flow of fluids in between the first retaining mechanism and the second retaining mechanism.

The current application claims a priority to the U.S. Provisional Patent application Ser. No. 62/636,543 filed on Feb. 28, 2018.

### FIELD OF THE INVENTION

The present invention relates generally to testing apparatuses and reaction enclosures. More specifically, the present invention relates to reactor microplates adapted for microgravity environments.

### BACKGROUND OF THE INVENTION

Reactor microplates allow researchers to have greater control over when to begin a microgravity project at the appropriate time when the pre-determined orbit and conditions have been reached. In general, a microplate reactor provides a structure where the reactants or research materials for zero-gravity research are kept separate. The microplate reactor further provides a mechanism which allows the reactants or research materials to be mixed within the microplate reactor, so the experiment or project can be carried out. The biggest obstacle most of the currently available devices face is providing a structure which allows various projects/experiments to be carried out while meeting the requirements of the National Aeronautics and Space Administration (NASA). Now, various devices and structures have been used to perform microgravity projects and/or experiments. Most provide a structure which meet the various mission requirements, such as weight limitations, space limitations, etc. However, few provide a structure which allows various microgravity projects and/or experiments to be carried out without risking the various reactants/research materials to accidentally mix while meeting NASA requirements. Thus, an objective of the present invention is to provide a reactor microplate which meets NASA requirements and provides a structure which allows for various experiments/projects to be carried out whenever the astronaut is ready to perform the experiments/projects.

### SUMMARY OF THE INVENTION

The present invention is a reactor microplate. The reactor microplate provides researchers control over when to begin the microgravity project/experiment once the reactor microplate reaches orbit. The fundamental concept behind the microplate reactor is a separation of materials intended for zero-gravity research, generally fluids or gels, between two chambers. The materials are allowed to mix when a crewmember rotates, by use of a standard tool, the valve cylinder. This opens the passage between the reaction chambers. The valve cylinder can take multiple forms and may be duplicated on either side of a common reaction chamber to provide activation/deactivation functionality. In order to meet NASA safety requirements, all valve cylinders are designed with double O-ring seals between the chambers and the external environment to provide double-redundant containment from release of potentially hazardous substances. Activation and deactivation chambers are functionally identical; though deactivation chambers are included, for example, in experiments where customers may want to keep biological samples that have been inoculated into the main chamber from the activation/deactivation chamber. In such a case, the deactivation chamber would contain preservatives which keep samples in stasis until their retrieval. The dimensions of the reactor microplate unit preferably are 127 by 85 by 20 millimeters in order to conform to the ANSI Standard for Microplate Footprint Dimensions (ANSI SLAS 1-2004/formerly ANSI/SBS 1-2004). The number of chambers in the reactor plate is variable depending on customer requirements. The dimensions of all wells are configurable to customer requirements. Reactions can be observed or measured through the film/containment windows. These windows are preferably made of Lexan, but can be configurable depending on the user's demands. In some cases, where ultraviolet (UV) wavelengths are needed to activate a given experiment, or to read the reaction in a plate reader using UV wavelengths, quartz windows may be used. Samples may either be viewed by microscope on orbit, read in a microplate reader on orbit, or returned to Earth for direct observation on removal from containment chambers. The body of the unit is preferably made of Delrin Plastic.

### BRIEF DESCRIPTION OF THE DRAWINGS

FIG. 1 is a perspective view of the present invention.

FIG. 2 is a perspective view of the present invention in a partially exploded state.

FIG. 3 is a right-side view of the present invention.

FIG. 4 is a cross-section cut view of the present invention taken along line A-A in FIG. 3.

FIG. 5 is a cross-section cut view of the present invention in an exploded state along line B-B in FIG. 3.

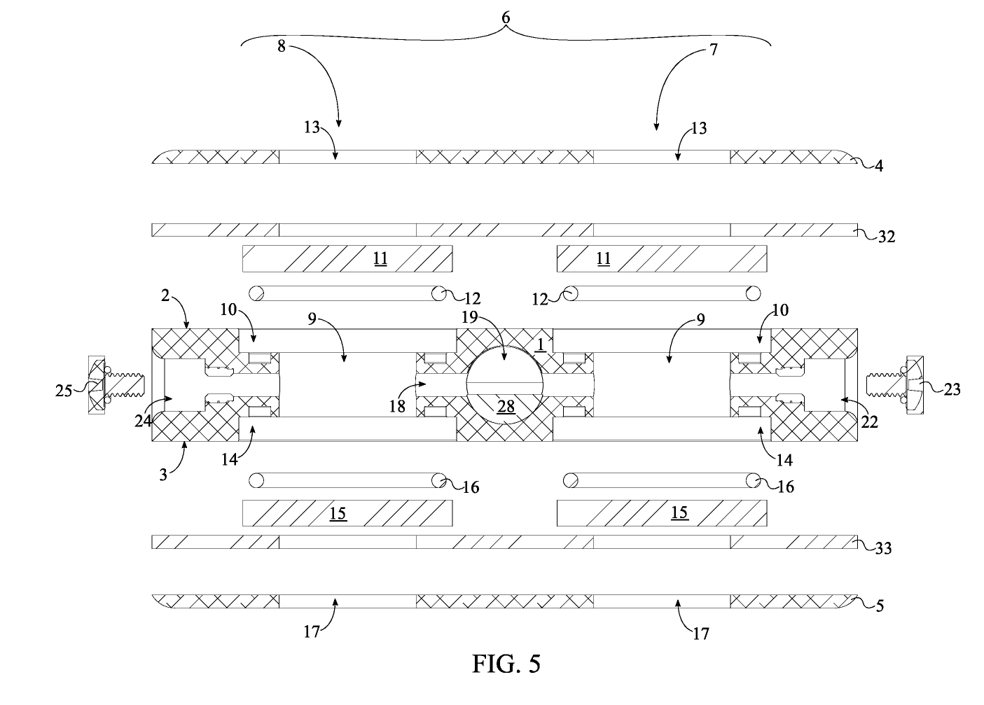

### DETAIL DESCRIPTIONS OF THE INVENTION

All illustrations of the drawings are for the purpose of describing selected versions of the present invention and are not intended to limit the scope of the present invention.

The present invention generally relates to a research apparatus intended for micro-gravity use. More specifically, the present invention is a reactor microplate that allows for safe mixing of solutions in orbit. Generally, the present invention is used to mix fluids without running a risk of potential exposure for an astronaut/researcher; for this, the present invention meets the safety requirements set forth by the National Aeronautics and Space Administration (NASA) through multiple redundant containing systems.

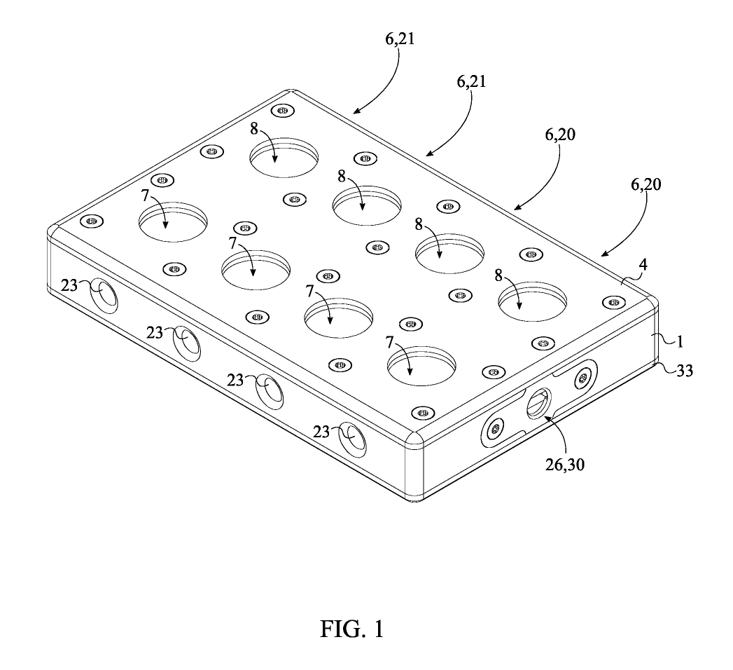

Referring to FIG. 1, in the simplest embodiment, the present invention comprises a planar housing 1, a first cover plate 4, and an at least one chamber-mixing assembly 6. The planar housing 1 is an elongated support structure that houses and contains the solutions necessary for an at least one experiment in orbit. The preferred planar housing 1 is a rectangular prism, although alternative shapes, geometries, and objects may also be utilized. Additionally, the planar housing 1 is preferably composed of Delrin plastic, also known as polyoxymethylene as this material provides high stiffness, low friction, and dimensional stability. The first cover plate 4 encloses the chamber-mixing assembly 6 and prevents potentially hazardous substances from contaminating the external environment around the present invention. The chamber-mixing assembly 6 contains the solutions necessary for the experiment or project, i.e. the solutions to be mixed with each other. Specifically, the chamber-mixing assembly 6 comprises a first retaining mechanism 7, a second retaining mechanism 8, a mixing channel 18, and an activation valve 19. The first retaining mechanism 7 and the second retaining mechanism 8 outline/delineate two separate storage spaces for mixing solutions. The first retaining mechanism 7 and the second retaining mechanism 8 are positioned offset to each other, across the planar housing 1. The first retaining mechanism 7 and the second retaining mechanism 8 each comprise a reaction chamber 9. The reaction chamber 9 normally traverses into the planar housing 1 from a top surface 2 of the planar housing 1. Specifically, the reaction chamber 9 is preferably implemented as a circular cavity to reduce the possible number of stress points. The size, depth, and the geometry of the reaction chamber 9 is subject to change to meet the holding requirements for the materials, solutions, required for the experiment. The mixing channel 18 is positioned in between the first retaining mechanism 7 and the second retaining mechanism 8 in order to connect the first retaining mechanism 7 and the second retaining mechanism 8 together. The mixing channel 18 traverses into the planar housing 1 from the first retaining mechanism 7 to the second retaining mechanism 8. This puts the first retaining mechanism 7 in fluid communication with the second retaining mechanism 8. The activation valve 19 regulates the flow of fluids through the mixing channel 18 and, therefore, in between the first retaining mechanism 7 and the second retaining mechanism 8. For this, the activation valve 19 is mechanically integrated into the planar housing 1, in between the first retaining mechanism 7 and the second retaining mechanism 8. Resultantly, the reaction chamber 9 of the first retaining mechanism 7, the reaction chamber 9 of the second retaining mechanism 8, and the mixing channel 18 are in fluid communication with each other through the activation valve 19. The first cover plate 4 encloses the chamber-mixing assembly 6 and provides additional redundant protection against potential leak or exposure of the fluids, gasses, and solutions contained within chamber-mixing assembly 6. Specifically, the first cover plate 4 is mounted adjacent and parallel to the top surface 2 of the planar housing 1.

To allow astronauts/researchers to view or take measurements of the reaction occurring within the chamber-mixing assembly 6, the present invention includes observation windows. Specifically, the first retaining mechanism 7 and the second retaining mechanism 8 each further comprises a first disk-receiving hole 10, a first transparent disk 11, a first annular seal 12, and a first cover hole 13. The first disk-receiving hole 10 is positioned concentric with the reaction chamber 9. Additionally, the first disk-receiving hole 10 normally traverses into the planar housing 1 from the top surface 2 to allow the first transparent disk 11 to be mounted to the planar housing 1 flush with the top surface 2. The first annular seal 12 is a flexible ring that prevents solution leaking at the interface between the first transparent disk 11 and the planar housing 1. For this, the first annular seal 12 is concentrically positioned within the first disk-receiving hole 10. The first transparent disk 11 is transparent disk that allows the astronaut/researcher to view inside the reaction chamber 9. The first transparent disk 11 is concentrically mounted within the first disk-receiving hole 10 with the first annular seal 12 being pressed into an O-ring housing in between the planar housing 1 and the first transparent disk 11. Specifically, the first annular seal 12 and the first transparent disk 11 are mounted to the planar housing 1 by the first cover. The first cover plate 4 is positioned adjacent to the first transparent disk 11, opposite the planar housing 1; thus, the first annular seal 12 and the first transparent disk 11 are pressed in between the planar housing 1 and the first cover. The first cover plate 4 is attached to the planar housing 1 through a plurality of first fasteners; wherein each of the plurality of first fasteners may be a screw, a bolt, a screw and threaded bushing combination, and any other standard fastener. The plurality of first fasteners is distributed about the first cover plate 4 with each of the plurality of first fasteners traversing through the first cover plate 4 and into the planar housing 1. The first cover hole 13 exposes a portion of the first transparent disk 11 to allow the astronaut/researcher to see inside the reaction chamber 9. The first cover hole 13 is concentrically positioned with the first transparent disk 11 and normally traverses through the first cover. Additionally, the first cover hole 13 is sized partially smaller than the first transparent disk 11 to ensure that the outer perimeter of the first transparent disk 11 is pressed against the first cover plate 4.

In one embodiment, the present invention provides the astronaut/researcher an additional window for the first retaining mechanism 7 and the second retaining mechanism 8, integrated into a bottom surface 3 of the planar housing 1. In this embodiment, the reaction chamber 9 of the first retaining mechanism 7 and the reaction chamber 9 of the second retaining mechanism 8 each further traverse through the planar housing 1 from the top surface 2 to the bottom surface 3. Additionally, the present invention further comprises a second cover plate 5; and, the first retaining mechanism 7 and the second retaining mechanism 8 each further comprise a second disk-receiving hole 14, a second transparent disk 15, a second annular seal 16, and a second cover hole 17. In general, the top surface 2 and the bottom surface 3 are symmetrical about a top plane of the present invention. The description below applies to both the first retaining mechanism 7 and the second retaining mechanism 8. The second disk-receiving hole 14 is positioned concentric with the reaction chamber 9. Additionally, the second disk-receiving hole 14 normally traverses into the planar housing 1 from the bottom surface 3 to allow the second transparent disk 15 to be mounted to the planar housing 1 flush with the bottom surface 3. The second annular seal 16 is a flexible ring that prevents solution leaking at the interface between the second transparent disk 15 and the planar housing 1. For this, the second annular seal 16 is concentrically positioned within the second disk-receiving hole 14. The second transparent disk 15 is a transparent disk that allows the astronaut/researcher to view inside the reaction chamber 9. The second transparent disk 15 is concentrically mounted within the second disk-receiving hole 14 with the second annular seal 16 being pressed in between the planar housing 1 and the second transparent disk 15. Specifically, the second annular seal 16 and the second transparent disk 15 are mounted to the planar housing 1 by the second cover. The second cover plate 5 is mounted parallel and adjacent to the bottom surface 3 of the planar housing 1. Thus, the second annular seal 16 and the second transparent disk 15 are pressed in between the planar housing 1 and second first cover. The second cover plate 5 is attached to the planar housing 1 through a plurality of second fasteners; wherein each of the plurality of second fasteners may be a screw, a bolt, a screw and threaded bushing combination, and any other standard fastener. The plurality of second fasteners is distributed about the second cover plate 5 with each of the plurality of second fasteners traversing through the second cover plate 5 and into the planar housing 1. The second cover hole 17 exposes a portion of the second transparent disk 15 to allow the astronaut/researcher to see inside the reaction chamber 9. The second cover hole 17 is concentrically positioned with the second transparent disk 15 and normally traverses through the first cover. Additionally, the second cover hole 17 is sized partially smaller than the second transparent disk 15 to ensure the that the outer perimeter of the second transparent disk 15 is pressed against the second cover plate 5.

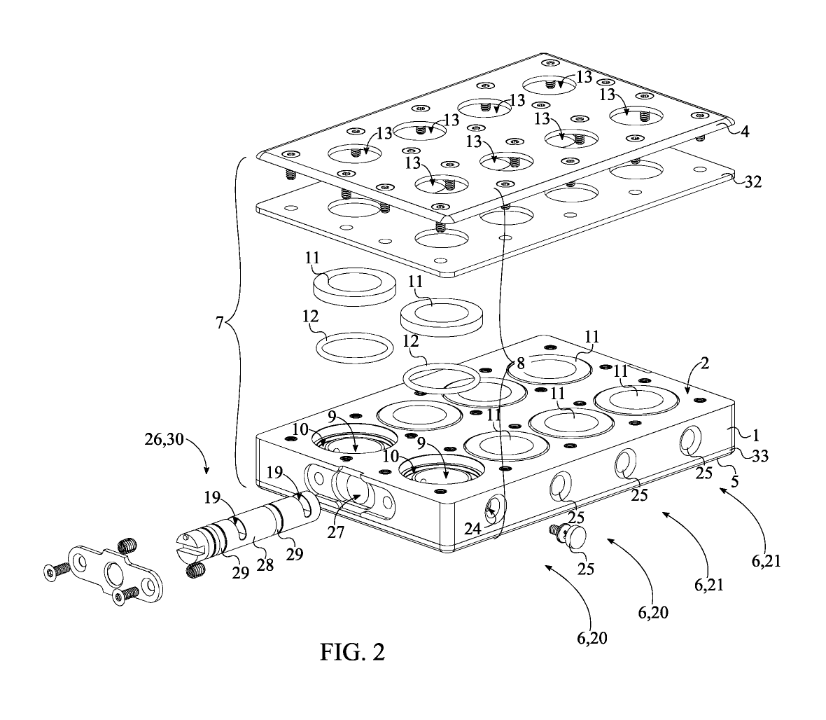

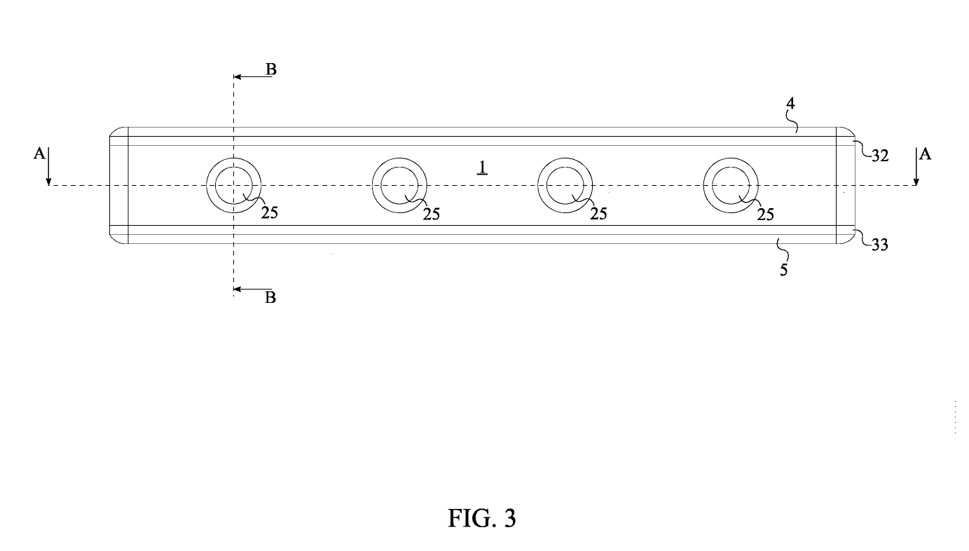

Referring to FIG. 2 and FIG. 3, the present invention further comprises a first gasket 32 and a second gasket 33 that can prevent leakage of solutions from the mixing-chamber assembly. Specifically, the first gasket 32 prevents leakage at the interface between the top surface 2 of the planar housing 1 and the first cover plate 4. The first gasket 32 is positioned in between the planar housing 1 and the first cover plate 4. Additionally, the first gasket 32 is mounted parallel and adjacent to the planar housing 1. The first gasket 32 is designed to span and cover the top surface 2 of the planar housing 1. Additionally, the first gasket 32 includes a plurality of cutouts to compliment the plurality of first fasteners and the mixing-chamber assembly. Similarly, the second gasket 33 prevents leakage at the interface between the bottom surface 3 of the planar housing 1 and the second cover plate 5. The second gasket 33 is positioned in between the planar housing 1 and the second cover plate 5. Additionally, the second gasket 33 is mounted parallel and adjacent to the planar housing 1. The second gasket 33 is designed to span and cover the bottom surface 3 of the planar housing 1. Additionally, the second gasket 33 includes a plurality of cutouts to compliment the plurality of second fasteners and the mixing-chamber assembly. Furthermore, sealants may be used directly or about the first gasket 32 and the second gasket 33 to accomplish a stronger seal.

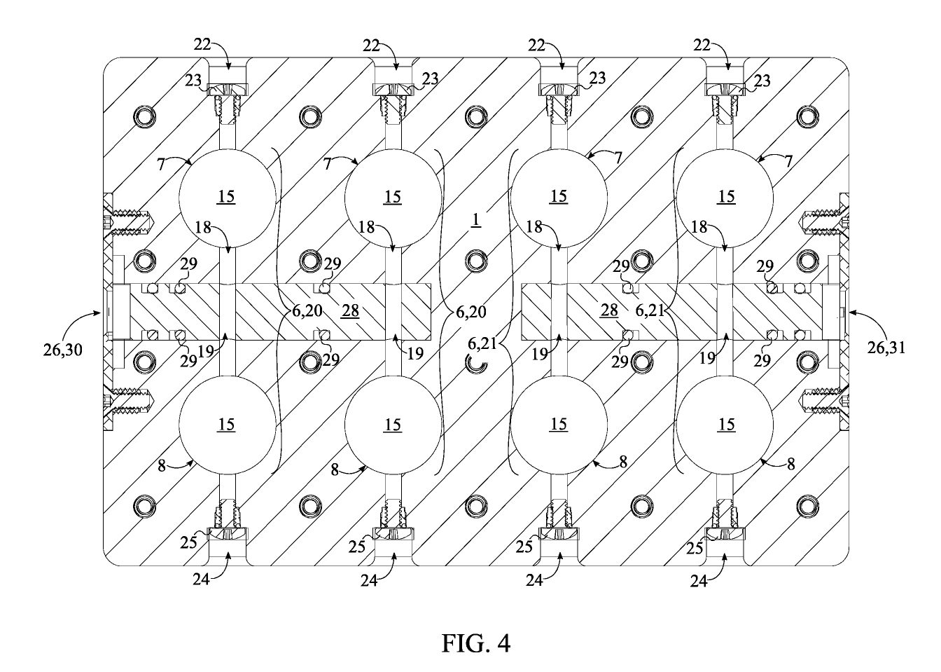

To load solutions, gases, or gels into the present invention, the chamber-mixing assembly 6 further comprises a first loading port 22, a first plug 23, a second loading post, and a second plug 25. The first loading port 22 allows for materials to be loaded into the first retaining mechanism 7. Referring to FIG. 4, the first loading port 22 is positioned adjacent to the first retaining mechanism 7. Additionally, the first loading port 22 laterally traverses into the planar housing 1, intersecting the reaction chamber 9 of the first retaining mechanism 7. It is preferred that the first loading port 22 is aligned with the mixing channel 18 for more efficient manufacturing. The first plug 23 seals the first loading port 22, thus sealing the solution within the first retaining mechanism 7. The first plug 23 is positioned within the first loading port 22 and is attached to the planar housing 1. Additionally, the first plug 23 allows for the extraction of the solution(s) from the first retaining mechanism 7 after the experiment is completed without requiring the full disassembly of the present invention.

The second loading port 24 allows for materials to be loaded into the second retaining mechanism 8. Referring to FIG. 4, the second loading port 24 is positioned adjacent to the second retaining mechanism 8. Additionally, the second loading port 24 laterally traverses into the planar housing 1, intersecting the reaction chamber 9 of the second retaining mechanism 8. It is preferred that the second loading port 24 is aligned with the mixing channel 18 and the first loading port 22 for more efficient manufacturing. The second plug 25 seals the second loading port 24, thus sealing the solution within the second retaining mechanism 8. The second plug 25 is positioned within the second loading port 24 and is attached to the planar housing 1. Additionally, the second plug 25 allows for the extraction of the solution(s) from the second retaining mechanism 8 after the experiment is completed without requiring the full disassembly of the present invention.

Referring to FIG. 2, the first plug 23 and the second plug 25 are implemented as a screw, a threaded insert, and a cap. The threaded insert is integrated into the planar housing 1. The screw is threadably attached within the threaded insert to allow for easy loading and unloading of solutions within either the first retaining mechanism 7 or the second retaining mechanism 8. The cap is placed over the screw head and epoxied in place to provide the secondary, redundant seal for the loading ports.

Referring to FIG. 2, the present invention further comprises an at least one valve control assembly 26. The valve control assembly 26 acts as the engagement element for the astronaut/researcher to set the configuration of the activation valve 19. The valve control assembly 26 comprises a cylinder-receiving hole 27, a cylindrical shaft 28, a retaining plate, an access hole, and an engagement feature. The valve control assembly 26 with the activation valve 19 control the flow of fluid through the mixing channel 18. For this, the activation valve 19 is a connecting groove. The cylinder-receiving hole 27 is oriented perpendicular to the mixing channel 18. Additionally, the cylinder-receiving hole 27 traverses into the planar housing 1, intersecting the mixing channel 18, thus configuring the cylinder-receiving hole 27 and the mixing channel 18 to be in fluid communication with each other. The cylindrical shaft 28 is concentrically positioned within the cylinder-receiving hole 27 such that the mixing channel 18 is divided into two and fluid flow is obstructed by the cylindrical shaft 28. For this, the diameter of the cylinder-receiving hole 27 and the cylindrical shaft 28 are greater than the diameter of the mixing channel 18. The connecting groove allows for fluid to flow through the mixing channel 18 and thus is positioned coincident with the mixing channel 18; the connecting groove is oriented along the mixing channel 18. Additionally, the connecting groove laterally traverses into the cylindrical shaft 28. To control the flow of fluid across the mixing channel 18, the cylindrical shaft 28 is rotatably mounted to the planar housing 1. To allow for fluid flow across the mixing channel 18, the cylindrical shaft 28 is rotated until the connecting groove is positioned within the mixing channel 18. This configuration allows for fluid to flow across the mixing channel 18.

The retaining plate secures the cylindrical shaft 28 within the cylinder-receiving hole 27. Thus, the retaining plate is positioned perpendicular to the cylindrical shaft 28 and is laterally connected to the planar housing 1. The access hole exposes one end of the cylindrical shaft 28 such that a tool may be used to physically engage and rotate the cylindrical shaft 28. The access hole is concentrically positioned with the cylindrical shaft 28 and normally traverses through the retaining plate. The engagement feature allows an external tool to engage and rotate the cylindrical shaft 28. The engagement feature is positioned within the access hole and mechanically integrated into the cylindrical shaft 28. It is preferred that the engagement feature is a slot to allow a flat-head screw driver to engage and rotate the cylindrical shaft 28.

In one embodiment, the valve control assembly 26 further comprises a semi-annular track and a track slider that limit the radial range of the cylindrical shaft 28. The semi-annular track is positioned concentric with the access hole. Additionally, the semi-annular track is integrated in between the cylindrical shaft 28 and the retaining plate. The track slider is terminally integrated into the cylindrical shaft 28 and is mechanically engaged with the semi-annular track. This provides a radial rotating range to the cylindrical shaft 28, thus providing an easy means of determining the location of the connecting groove.

Referring to FIG. 4, the present invention may be implemented to allow for a multitude of experiments to be run in a single implementation of the present invention. For this, the at least one chamber-mixing assembly 6 is a plurality of mixing assemblies. The plurality of mixing assemblies is distributed along the planar housing 1; the number within the plurality of mixing assemblies is subject to change. The plurality of mixing assemblies is used to run a plurality of experiments simultaneously. For this embodiment, the cylinder-receiving hole 27 extends along the plurality of mixing assemblies. Specifically, the cylinder-receiving hole 27 intersects with the mixing channel 18 for each of the plurality of mixing assemblies. This allows the cylindrical shaft 28 to control the flow of fluid within each of the plurality of mixing assemblies. Referring to FIG. 4, the connecting groove for each of the plurality of mixing assemblies laterally traverses into the cylindrical shaft 28 such that turning the cylindrical shaft 28 will in turn activate each of the plurality of mixing assemblies. To prevent cross contamination in between the plurality of mixing assemblies, the present invention further comprises a plurality of shaft seals 29. Each of the plurality of shaft seals 29 is a ring seal that prevents fluids to flow along the cylinder-receiving hole 27. The plurality of shaft seals 29 is distributed along the cylindrical shaft 28. In particular, the plurality of shaft seals 29 is interspersed amongst the plurality of mixing assemblies with each of the plurality of seals being concentrically mounted to the cylindrical shaft 28. It is preferred that an at least two seals from the plurality of shaft seals 29 are positioned adjacent to the retaining plate to prevent leakage to the environment about the retaining plate.

In one embodiment, the at least one valve control assembly 26 comprises a first control assembly 30 and a second control assembly 31. The first control assembly 30 and the second control assembly 31 divide the plurality of mixing assemblies in two and allow the astronaut/researcher to initiate different experiments at different times. For this, the first control assembly 30 and the second control assembly 31 are positioned opposite to each other along the planar housing 1. Specifically, the cylinder-receiving hole 27 of the first control assembly 30 extends along a first set of mixing assemblies 20 from the plurality of mixing assemblies. Accordingly, the connecting groove from each of the first set of mixing assemblies 20 laterally traverse into the cylindrical shaft 28 of the first control assembly 30. The cylinder-receiving hole 27 of the second control assembly 31 extends along a second set of mixing assemblies 21 from the plurality of mixing assemblies. Accordingly, the connecting groove from each of the second set of mixing assemblies 21 laterally traverse into the cylindrical shaft 28 of the second control assembly 31.

Although the invention has been explained in relation to its preferred embodiment, it is to be understood that many other possible modifications and variations can be made without departing from the spirit and scope of the invention as hereinafter claimed.

What is claimed is:

1. A reactor microplate comprising:
a planar housing;
a first cover plate;
an at least one chamber-mixing assembly;
the chamber-mixing assembly comprises a first retaining mechanism, a second retaining mechanism, a mixing channel, and an activation valve;
the first retaining mechanism and the second retaining mechanism each comprise a reaction chamber;
the first retaining mechanism and the second retaining mechanism being positioned offset to each other, across the planar housing;
the reaction chamber normally traversing into the planar housing from a top surface of the planar housing;
the mixing channel being positioned in between the first retaining mechanism and the second retaining mechanism;
the mixing channel traversing into the planar housing from the first retaining mechanism to the second retaining mechanism;
the activation valve being mechanically integrated into the planar housing, in between the first retaining mechanism and the second retaining mechanism;
the reaction chamber of the first retaining mechanism, the reaction chamber of the second retaining mechanism, and the mixing channel being in fluid communication with each other through the activation valve; and
the first cover plate being mounted adjacent and parallel to the top surface of the planar housing.

2. The reactor microplate as claimed in claim 1 comprising:
an at least one valve control assembly;
the valve control assembly comprises a cylinder-receiving hole and a cylindrical shaft;
wherein the activation valve is a connecting groove;
the cylinder-receiving hole being oriented perpendicular to the mixing channel;
the cylinder-receiving hole laterally traversing into the planar housing, intersecting the mixing channel;
the cylindrical shaft being concentrically positioned within the cylinder-receiving hole;
the cylindrical shaft being rotatably mounted to the planar housing;
the connecting groove being positioned coincident with the mixing channel; and
the connecting groove laterally traversing into the first cylindrical shaft.

3. The reactor microplate as claimed in claim 2 comprising:
the valve control assembly further comprises a plurality of shaft seals;
the at least one chamber-mixing assembly being a plurality of mixing assemblies;
the plurality of mixing assemblies being distributed along the planar housing;
the cylinder-receiving hole extending along the plurality of mixing assemblies;
the cylinder-receiving hole intersecting with the mixing channel for each of the plurality of mixing assemblies;
the connecting groove for each of the plurality of mixing assemblies laterally traversing into the cylindrical shaft;
the plurality of shaft seals being distributed along the cylindrical shaft;
the plurality of shaft seals being interspersed amongst the plurality of mixing assemblies; and
each of the plurality of shaft seals being concentrically mounted to the cylindrical shaft.

4. The reactor microplate as claimed in claim 3 comprising:
the at least one valve control assembly comprises a first control assembly and a second control assembly;
the first control assembly and the second control assembly being positioned opposite to each other along the planar housing;
the cylinder-receiving hole of the first control assembly extending along a first set of mixing assemblies from the plurality of mixing assemblies;
the cylinder-receiving hole of the second control assembly extending along a second set of mixing assemblies from the plurality of mixing assemblies;
the connecting groove from each of the first set of mixing assemblies laterally traversing into the cylindrical shaft of the first control assembly; and
the connecting groove from each of the second set of mixing assemblies laterally traversing into the cylindrical shaft of the second control assembly.

5. The reactor microplate as claimed in claim 1 comprising:
the chamber-mixing assembly further comprises a first loading port and a first plug;
the first loading port being positioned adjacent to the first retaining mechanism;
the first loading port laterally traversing into the planar housing, intersecting the reaction chamber of the first retaining mechanism;
the first plug being positioned within the first loading port; and
the first plug being attached to the planar housing.

6. The reactor microplate as claimed in claim 1 comprising:
the chamber-mixing assembly further comprises a second loading port and a second plug;
the second loading port being positioned adjacent to the second retaining mechanism;
the second loading port laterally traversing into the planar housing, intersecting the reaction chamber of the second retaining mechanism;
the second plug being positioned within the second loading port; and
the second plug being attached to the planar housing.

7. The reactor microplate as claimed in claim 1 comprising:
a first gasket;
the first gasket being positioned in between the planar housing and the first cover plate; and
the first gasket being mounted parallel and adjacent to the planar housing.

8. The reactor microplate as claimed in claim 1 comprising:
the first retaining mechanism and the second retaining mechanism each further comprises a first disk-receiving hole, a first transparent disk, a first annular seal, and a first cover hole;
the first disk-receiving hole being positioned concentric with the reaction chamber;
the first disk-receiving hole normally traversing into the planar housing from the top surface of the planar housing;
the first annular seal being concentrically positioned within the first disk-receiving hole;
the first transparent disk being concentrically mounted within the first disk-receiving hole;
the first annular seal being pressed in between the planar housing and the first transparent disk;
the first cover plate being positioned adjacent to the first transparent disk, opposite the planar housing;
the first cover hole being positioned concentric with the reaction chamber; and
the first cover hole normally traversing through the first cover plate.

9. The reactor microplate as claimed in claim 1 comprising:
a second cover plate;
the reaction chamber further traversing through the planar housing from the top surface of the planar housing to a bottom surface of the planar housing;
the first retaining mechanism and the second retaining mechanism each further comprises a second disk-receiving hole, a second transparent disk, a second annular seal, and a second cover hole;
the second disk-receiving hole being positioned concentric with the reaction chamber;
the second disk-receiving hole normally traversing into the planar housing from the bottom surface of the planar housing;
the second annular seal being concentrically positioned within the second disk-receiving hole;
the second transparent disk being concentrically mounted within the second disk-receiving hole;
the second annular seal being pressed in between the planar housing and the second transparent disk;
the second cover plate being mounted parallel and adjacent to the bottom surface of the planar housing;
the second cover hole being positioned concentric with the reaction chamber; and
the second cover hole normally traversing through the second cover plate.

10. The reactor microplate as claimed in claim 9 comprising:
a second gasket;
the second gasket being positioned in between the planar housing and the second cover plate; and
the second gasket being mounted parallel and adjacent to the planar housing.

11. A reactor microplate comprising:
a planar housing;
a first cover plate;
an at least one chamber-mixing assembly;
an at least one valve control assembly;
the valve control assembly comprises a cylinder-receiving hole and a cylindrical shaft;
the chamber-mixing assembly comprises a first retaining mechanism, a second retaining mechanism, a mixing channel, and an activation valve;
the first retaining mechanism and the second retaining mechanism each comprise a reaction chamber;
the first retaining mechanism and the second retaining mechanism being positioned offset to each other, across the planar housing;
the reaction chamber normally traversing into the planar housing from a top surface of the planar housing;
the mixing channel being positioned in between the first retaining mechanism and the second retaining mechanism;
the mixing channel traversing into the planar housing from the first retaining mechanism to the second retaining mechanism;
the activation valve being mechanically integrated into the planar housing, in between the first retaining mechanism and the second retaining mechanism;
the reaction chamber of the first retaining mechanism, the reaction chamber of the second retaining mechanism, and the mixing channel being in fluid communication with each other through the activation valve;
the first cover plate being mounted adjacent and parallel to the top surface of the planar housing;
wherein the activation valve is a connecting groove;
the cylinder-receiving hole being oriented perpendicular to the mixing channel;
the cylinder-receiving hole laterally traversing into the planar housing, intersecting the mixing channel;
the cylindrical shaft being concentrically positioned within the cylinder-receiving hole;
the cylindrical shaft being rotatably mounted to the planar housing;
the connecting groove being positioned coincident with the mixing channel; and
the connecting groove laterally traversing into the first cylindrical shaft.

12. The reactor microplate as claimed in claim 11 comprising:
the valve control assembly further comprises a plurality of shaft seals;
the at least one chamber-mixing assembly being a plurality of mixing assemblies;
the plurality of mixing assemblies being distributed along the planar housing;
the cylinder-receiving hole extending along the plurality of mixing assemblies;
the cylinder-receiving hole intersecting with the mixing channel for each of the plurality of mixing assemblies;
the connecting groove for each of the plurality of mixing assemblies laterally traversing into the cylindrical shaft;
the plurality of shaft seals being distributed along the cylindrical shaft;
the plurality of shaft seals being interspersed amongst the plurality of mixing assemblies; and
each of the plurality of shaft seals being concentrically mounted to the cylindrical shaft.

13. The reactor microplate as claimed in claim 12 comprising:
the at least one valve control assembly comprises a first control assembly and a second control assembly;
the first control assembly and the second control assembly being positioned opposite to each other along the planar housing;
the cylinder-receiving hole of the first control assembly extending along a first set of mixing assemblies from the plurality of mixing assemblies;
the cylinder-receiving hole of the second control assembly extending along a second set of mixing assemblies from the plurality of mixing assemblies;
the connecting groove from each of the first set of mixing assemblies laterally traversing into the cylindrical shaft of the first control assembly; and
the connecting groove from each of the second set of mixing assemblies laterally traversing into the cylindrical shaft of the second control assembly.

14. The reactor microplate as claimed in claim 1 comprising:
the chamber-mixing assembly further comprises a first loading port and a first plug;
the first loading port being positioned adjacent to the first retaining mechanism;
the first loading port laterally traversing into the planar housing, intersecting the reaction chamber of the first retaining mechanism;
the first plug being positioned within the first loading port; and
the first plug being attached to the planar housing.

15. The reactor microplate as claimed in claim 1 comprising:
the chamber-mixing assembly further comprises a second loading port and a second plug;
the second loading port being positioned adjacent to the second retaining mechanism;
the second loading port laterally traversing into the planar housing, intersecting the reaction chamber of the second retaining mechanism;
the second plug being positioned within the second loading port; and
the second plug being attached to the planar housing.

16. The reactor microplate as claimed in claim 1 comprising:
a first gasket;
the first gasket being positioned in between the planar housing and the first cover plate; and
the first gasket being mounted parallel and adjacent to the planar housing.

17. The reactor microplate as claimed in claim 1 comprising:
the first retaining mechanism and the second retaining mechanism each further comprises a first disk-receiving hole, a first transparent disk, a first annular seal, and a first cover hole;
the first disk-receiving hole being positioned concentric with the reaction chamber;
the first disk-receiving hole normally traversing into the planar housing from the top surface of the planar housing;
the first annular seal being concentrically positioned within the first disk-receiving hole;
the first transparent disk being concentrically mounted within the first disk-receiving hole;
the first annular seal being pressed in between the planar housing and the first transparent disk;
the first cover plate being positioned adjacent to the first transparent disk, opposite the planar housing;
the first cover hole being positioned concentric with the reaction chamber; and
the first cover hole normally traversing through the first cover plate.

18. The reactor microplate as claimed in claim 1 comprising:
a second cover plate;
the reaction chamber further traversing through the planar housing from the top surface of the planar housing to a bottom surface of the planar housing;
the first retaining mechanism and the second retaining mechanism each further comprises a second disk-receiving hole, a second transparent disk, a second annular seal, and a second cover hole;
the second disk-receiving hole being positioned concentric with the reaction chamber;
the second disk-receiving hole normally traversing into the planar housing from the bottom surface of the planar housing;
the second annular seal being concentrically positioned within the second disk-receiving hole;
the second transparent disk being concentrically mounted within the second disk-receiving hole;
the second annular seal being pressed in between the planar housing and the second transparent disk;
the second cover plate being mounted parallel and adjacent to the bottom surface of the planar housing;
the second cover hole being positioned concentric with the reaction chamber; and
the second cover hole normally traversing through the second cover plate.

19. The reactor microplate as claimed in claim 18 comprising:
a second gasket;
the second gasket being positioned in between the planar housing and the second cover plate; and
the second gasket being mounted parallel and adjacent to the planar housing.
